(19) United States
(12) Patent Application Publication
(10) Pub. No.: US 2020/0239811 A1
(43) Pub. Date: Jul. 30, 2020

(54) NATURALLY DERIVED FABRIC CONDITIONING COMPOSITIONS AND RELATED METHODS

(71) Applicant: Inolex Investment Corporation, Wilmington, DE (US)

(72) Inventor: Rocco V. Burgo, Mullica Hill, NJ (US)

(73) Assignee: Inolex Investment Corporation

(21) Appl. No.: 16/850,938

(22) Filed: Apr. 16, 2020

Related U.S. Application Data
(63) Continuation of application No. PCT/US2018/056105, filed on Oct. 16, 2018.
(60) Provisional application No. 62/572,882, filed on Oct. 16, 2017.

(51) Int. Cl. C11D 3/00; C11D 3/50; C11D 3/30; C11D 3/22; C11D 3/20; C11D 11/00

(52) U.S. Cl. CPC C11D 3/001; C11D 3/0036; C11D 3/50; C11D 11/0017; C11D 3/225; C11D 3/2093; C11D 3/30

(57) ABSTRACT

Included within the scope of the invention are compositions for conditioning fabrics comprising a fabric conditioning agents; such agents being selected from a) a neutralized amino acid ester represented by formula (I):

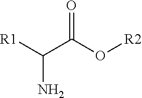

wherein R¹ is an alkyl group having one to ten carbon atoms and R² is a carbon chain having ten to fifty carbon atoms; b) a neutralized amino acid ester represented by formula (II):

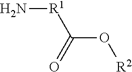

wherein R³ is an alkyl group having one to 6 to 24 carbon atoms and R⁴ independently represents an alkyl group having 6 to 36 carbon atoms; and c) a mixture of a) and b); and a carrier selected from water, an alcohol, and an alcoholic water mixture. Also included are related methods of use and manufacture.

### CROSS REFERENCE TO RELATED APPLICATIONS

This application is a continuation of US-designating International Patent Application No. PCT/US2018/056105, filed Oct. 16, 2018, which in turn claims the benefit under 35 U.S.C. § 119(e) of U.S. Provisional Patent Application Ser. No. 62/572,882, filed Oct. 16, 2017, each entitled “Naturally Derived Fabric Conditioning Compositions”, the entire disclosures of each of which are incorporated herein by reference.

### BACKGROUND OF THE INVENTION

Sales of “natural” products within the home care industry continue to show significant growth. Popular culture and the media has driven this growth by popularizing the idea that there may be potential adverse effects to the body (toxicity) and to the environment (pollution, hastening of climate change, and environmental toxicity) associated with the use of ingredients derived from fossil fuels. The industry has rapidly advanced its attempts to identify ingredients described as “renewable” and “sustainable,” that is, ingredients of non-fossil fuel, non-animal and non-genetically modified origin for use in the formulation of virtually all types of home and institutional care products.

In many instances, replacements or substitutes for many ingredients that are historically of “non-natural” origin have been developed. Examples of this are the replacement of mineral oils, silicones, and petrochemically-derived synthetic esters with vegetable oils and natural esters, synthetic fragrances with essential oils, and petrochemical preservatives with certain extracts. However, there remains in the art a need for a fabric conditioning composition that is effective and yet can be formulated and marketed as natural.

### BRIEF SUMMARY OF THE INVENTION

Included within the scope of the invention are compositions for conditioning fabrics comprising a fabric conditioning agents; such agents being selected from a) a neutralized amino acid ester represented by formula (I):

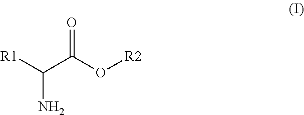

wherein R¹ is an alkyl group having one to ten carbon atoms and R² is a carbon chain having ten to fifty carbon atoms; b) a neutralized amino acid ester represented by formula (II):

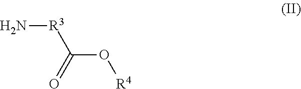

wherein R³ is an alkyl group having one to 6 to 24 carbon atoms and R⁴ independently represents an alkyl group having 6 to 36 carbon atoms; and c) a mixture of a) and b); and a carrier selected from water, an alcohol, and an alcoholic water mixture. Also included are related methods of use and manufacture.

### BRIEF DESCRIPTION OF THE DRAWINGS

The foregoing summary, as well as the following detailed description of preferred embodiments of the invention, will be better understood when read in conjunction with the appended drawings. The invention is not limited to the precise arrangements and instrumentalities shown. In the drawings:

FIG. 1 is a table listing United States patents that identify ingredients that may be incorporated into the fabric conditioning compositions of the invention; and

FIG. 2 shows an infrared spectrum of Brassicyl L-isoleucinate esylate (BLIE).

### DETAILED DESCRIPTION OF THE INVENTION

The invention includes fabric conditioning compositions for the treatment of textiles and/or the fibers from which they are made, as well as related methods. The textiles may be in any form, including, clothes, bedding, home furnishings and other common domestic-type articles. Once treated with the compositions described herein, the textiles or fibers exhibit improved softness, fluffiness, reduced wrinkling, and/or improved fabric hand. If the textiles are clothes, bedding, household furnishings or other domestic-type articles, such articles routinely treated with the compositions of the invention may exhibit less wear over time as compared to untreated articles, and may clothes/garments may retain their shape longer over numerous wearings, as compared to untreated articles, particularly if the textile that forms the garment contains an elastic material or fiber.

Advantageously, the fabric treatment compositions described herein may be formulated to contain naturally derived ingredients (and therefore be commercialized with the label “Natural”), yet provide textile conditioning benefits equal or superior to fabric treatment compositions that contain non-naturally derived agents.

Products that are described as “natural”, “naturally-derived”, “clean” in the home and fabric care areas are highly popular with consumers. Consumers appear to have internalized the idea that such products are per se safer for humans and pets and less damaging to the environment, and therefore more ethical to use.

The industry has rapidly advanced its attempts to identify ingredients described as “renewable” and “sustainable” and “ethical”, that is, ingredients of natural origins, for use in fabric care products.

Although used in marketing materials, the terms “natural” or “naturally derive” have not yet been completely defined. However, efforts are underway by industry trade organizations to give the term a more concise and consistent meaning. It is generally recognized that materials derived from renewable and/or sustainable, non-fossil fuel sources, and which are not animal or genetically-modified organism (GMO) in origin are considered “natural” by the marketplace.

Currently, there are few fabric conditioning compositions (commonly called “fabric softeners”) that can be marketed as “natural” or naturally derived. The compositions described herein contain natural fabric conditioning agent(s), a carrier, and optionally other ingredients and can be formulated to meet the criteria of “natural” or “naturally-derived”. The compositions may be applied directly to the textile or fiber in liquid form in a hand or automatic laundering process, or may be applied via a wet or dry delivery device, such as, for example, a sheet impregnated/saturated with the composition of the invention, a capsule, cell, bead, particulate, tablet and the like containing the composition of the invention, a spray, an aerosol, and/or a mechanical dosing device used in the washer or dryer.

For purposes of clarity, while it is advantageous that the fabric conditioning composition described herein can be formulated and/or marketed as being completely “natural” and/or “naturally derived”, it can also be formulated using non-natural ingredients in part or wholly, as desired. For example, a formulator may find it necessary to include one or more non-natural ingredient; such formulation may still be within the scope of the invention.

The carrier may be water, an alcohol, and an alcoholic water mixture, for example, having water in an amount of about 1% to about 99%, and an alcohol in an amount of about 1% to about 99%.

Alcohols that may be used in the composition include any that are known in the fabric care art, solid or liquid, including for example, ethanol, isopropyl alcohol, cetearyl alcohol, cetyl alcohol, myristyl alcohol and behenyl alcohol and mixtures of the same.

The carrier may be present in any amount. Suitable amounts may include, for example, about 50% to about 99%, about 65% to about 98%, about 75% to about 97% and about 80% to about 96%, by weight of the total composition.

### Natural Fabric Conditioning Agents:

The compositions contain a cationic fabric conditioning agent or mixture of agents that has the advantage of being “natural” or naturally derived as they are amino acid esters derived from natural sources, yet at least as effective as non-natural fabric conditioning agents.

For example, the agent is a neutralized amino acid ester that is a reaction product of a neutral amino acid having a non-polar side chain with a long chain fatty alcohol. It is represented by formula (I):

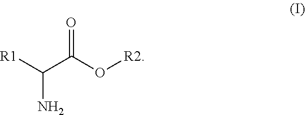

In (I), R¹ represents an alkyl group, which may be branched or linear. It may have one to ten carbon atoms or two to six carbon atoms. R² represents a carbon chain that may be linear or branched. It may contain ten to fifty carbon atoms or twenty-four to thirty-two carbon atoms.

The chain of R² may contain at least one unsaturated carbon atom. In an embodiment, R² is an alkyl group having eight to twenty four carbon atoms.

Amino acids for the formation of the ester of (I) include any that are neutral. In an embodiment, one may select L-alanine, L-valine, L-leucine and L-isoleucine. Particularly preferred, in some embodiments, is L-isoleucine.

It is preferred that the selected neutral amino acid for (I) is not derived from animal sources or GMO sources. In an embodiment, it may be preferred that the amino acid(s) are synthetic and/or derived from plants, algae, or other non-animal organisms. They may be obtained, for example, from vegetable matter by a fermentation process.

To obtain the ester of (I), the amine group of the amino acid is neutralized with an acid, and is reacted with a long chain fatty alcohol. Suitable fatty alcohols may be linear and/or branched and may additionally be saturated and/or unsaturated. It may be preferred that the fatty alcohol contains about ten to about fifty or about twenty-four to about thirty-two carbon atoms. In an embodiment, linear and/or branched fatty alcohols containing from about twelve to about twenty-two carbon atoms may be preferred.

Examples of suitable fatty alcohols include lauryl alcohol, myristyl alcohol, palmityl alcohol, stearyl alcohol, oleyl alcohol, isostearyl alcohol, arachidyl alcohol, behenyl alcohol and mixtures or combinations thereof. It is advisable that the fatty alcohols are derived from non-petrochemical sources.

The amine group of the amino acid ester may be fully or partially neutralized by an acid, to facilitate its cationic behavior. Any acid may be used, including organic and inorganic acids. Suitable acids include, without limitation, mineral acids, amino acids, hydrochloric acid, phosphoric acid, sulfuric acid, boric acid, and nitric acid. Suitable organic acids may be citric acid, ethanesulfonic acid, acetic acid, formic acid, and oxalic acid. Suitable amino acids may include glutamic acid and aspartic acid. In an embodiment, one may prefer ethanesulfonic acid that is derived from non-GMO ethanol.

An exemplary preferred neutralized amino acid ester may be Brassicyl L-isoleucine esylate (BLIE) or leucine isostearyl ester esylate (LIEE). Brassicyl L-isoleucine esylate (BLIE) may be derived from the esterification of Brassica alcohol with L-isoleucine esylate. L-isoleucine esylate may be prepared by reacting the amine group on isoleucine with ethanesulfonic acid. Brassica alcohol is a fatty alcohol that is derived from the splitting of high erucic acid rapeseed oil obtained from the Brassica genus of plants followed by hydrogenation. Brassica alcohol consists predominantly of stearyl (C₁₈), arachidyl (C₂₀) and behenyl (C₂₂) alcohols with minor quantities of lower and higher alkyl chain length alcohols.

The neutralized amino acid ester of (I) may be synthesized by methods commonly known in the art.

In an another embodiment, the natural fabric conditioning agent is neutralized an amino acid ester obtained from the esterification of (i) a neutral amino acid having an amine group that has been neutralized with an acid; with (ii) a fatty alcohol. It is represented by the structure of Formula (II):

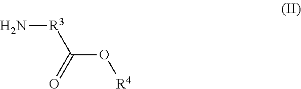

In Formula (II), R³ represents an alkyl group that may be branched or linear, substituted or unsubstituted. In an embodiment, it may be preferred that R³ may have one to 6 to 24 carbon atoms. In some embodiments, R³ may have 6, 7, 8, 9, 10, 11, 12, 13, 14, 15, 16, 17, 18, 19, 20, 21, 22, 23, or 24 carbon atoms. In an embodiment, R³ may be an alkyl group having 11 carbon atoms.

R⁴ independently represents an alkyl group, which may be linear or branched. In some embodiments, it may contain 6 to 36 carbon atoms. In some embodiments, R⁴ may have 6, 7, 8, 9, 10, 11, 12, 13, 14, 15, 16, 17, 18, 19, 20, 21, 22, 23, 24, 25, 26, 27, 28, 28, 30, 31, 32, 33, 34, 35, or 36 carbon atoms.

In either of R³ or R⁴, the carbons of the alkyl groups may independently each have at least one unsaturated carbon atom; in some embodiments, all the carbon atoms are unsaturated.

It may be preferred that the selected amino acid for use in (II) is natural. In some embodiments it is preferred that the amino acid for use in (II) is not derived from animal sources. In an embodiment, it may be preferred that the amino acid(s) are synthetic (laboratory-made) and/or derived from plants, algae, non-animal organisms, non-vertebrate organisms, and/or non-chordate organisms. In an embodiment, the amino acid may be obtained, for example, from vegetable matter by a fermentation process.

To obtain the ester of (II), the amine group of the amino acid is neutralized with an acid. To ensure that all the amine groups in a particular sample are neutralized, it may be preferred that the neutralization reaction is carried out using a stoichiometric excess of a strong acid, to prepare a neutralized amino acid (e.g., on having all of its amino groups neutralized).

To accomplish neutralization, any acid may be used, including organic and inorganic acids. Strong acids may be preferred. Suitable acids include, without limitation, mineral acids, amino acids, hydrochloric acid, phosphoric acid, sulfuric acid, boric acid, and nitric acid. Suitable organic acids may be citric acid, ethanesulfonic acid, acetic acid, formic acid, and oxalic acid. Suitable amino acids may include glutamic acid and aspartic acid. In an embodiment, one may prefer ethanesulfonic acid that is derived from non-GMO ethanol.

Subsequently, the neutralized amino acid is reacted with a fatty alcohol. Suitable fatty alcohols may be linear and/or branched and may additionally be saturated and/or unsaturated. It may be preferred that the fatty alcohol contains 6 to 36 carbon atoms.

Examples of suitable fatty alcohols may include, without limitation, lauryl alcohol, myristyl alcohol, palmityl alcohol, stearyl alcohol, oleyl alcohol, isostearyl alcohol, octyldodecanol, arachidyl alcohol, behenyl alcohol and mixtures or combinations thereof.

Other fatty alcohols may include 3-methyl-3 pentanol, ethchlorvynol, 1-octanol, 2-ethyl hexanol, 1-nonanol, undecanol, tridecanol, pentadecyl alcohol, palmitoleyl alcohol, heptadecyl alcohol, nonadecyl alcohol, Heneicosyl alcohol, erucyl alcohol, ceryl alcohol, 1-hepracosanol, cluytyl alcohol, 1-nonacosanol, myricyl alcohol, 1-dotriacontanol, and geddyl alcohol. Any mixture of two or more fatty alcohols may be used.

In some embodiments for the preparation of the ester of (II), it may be desirable that the fatty alcohols are derived from non-petrochemical sources, preferably renewable vegetable sources. Without limitation, examples may include be Brassica alcohol, rapeseed, palm, coconut or jojoba oils or a mixture of these or others. Brassica alcohol is the fatty alcohol derived from Brassica oil. In some embodiments, the Brassica alcohol selected may be derived from hydrogenated high erucic acid rapeseed (HEAR) oil, and may be a mixture of straight chain saturated fatty alcohols such as palmityl (C₁₆), stearyl (C₁₈), arachidyl (C₂₀), and behenyl (C₂₂) alcohols. The typical weight percentages of each alcohol in the fatty alcohol mixture may be about 3 wt. % palmitic, about 40 wt. % stearyl, about 10 wt. % arachidyl, and about 47 wt. % behenyl. These percentages can vary based upon seasonality, and varietal of rapeseed oil used as the parent vegetable source.

In an embodiment, the ester of (II) is prepared by reacting the amine group on the amino acid with an acid, for example, ethanesulfonic acid, prior to esterification. However, the neutralized amino acid ester of (II) may be synthesized by any methods commonly known or developed in the art.

Exemplary preferred neutralized amino acid esters of (II) may be, for example, octyldodecyl aminolaurate esylate (OAE), brassicyl aminolaurate esylate (BAE) and isostearyl aminolaurate esylate (IAE). OAE may be derived from the esterification of octylododecyl alcohol with 12-aminolauric esylate. BAE may be derived from the esterification of Brassica alcohol with 12-aminolauric esylate. IAE may be derived from the esterification of isostearyl alcohol and 12-aminolauric esylate.

The natural fabric conditioning agents of (I) and (II), described above, may be present in the fabric conditioning composition of the invention (alone or as a mixture of (I) and (II)) in any amount sufficient to provide the desired end benefit(s) to a given textile or fiber. For example, the total amount of natural fabric conditioning agent(s) present in the composition may be about 0.5% to about 50%, about 1% to about 20%, about 1.5% to about 10%, about 2% to about 9%, about 3%, about 4%, about 5%, about 6%, about 7%, or about 8% by weight of the total composition.

### Other Ingredients:

The fabric conditioning compositions the invention may contain any additional ingredients used in fabric conditioning, laundering, and/or fabric care compositions. Such ingredients include without limitation an antifoam agent, an antidepositon agent, a fragrance, a diol, a colorant and a co-softening agent (e.g., one that is not (I) or (II)). Others may include, without limitation, a preservative, a bacteriocide, a fungicide, a pH buffering agent, a perfume carrier, a fluoroescers, an hydrotropes, a soil-release agent, a polyelectrolyte, an enzyme, an optical brightening agent, an anti-shrinking agent, an anti-wrinkle agent, an anti-spotting agent, an anti-oxidant, an UV absorbing compound, an anti-corrosion agent, a drape imparting agent, an anti-static agents, an ironing aid, a dye, an antibacterial, an odor, preventing compound, a perfume encapsulate, cotton seed oil, tea tree oil, Aloe Vera extract, propylene glycol, dipropylene glycol, an opacifier, a pearlescer and mixtures of the same.

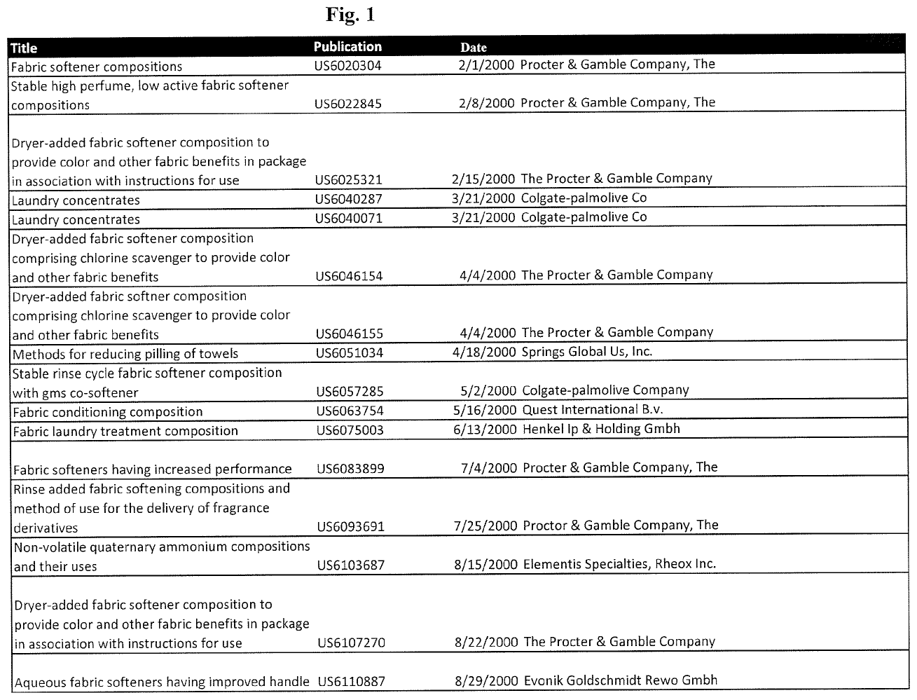

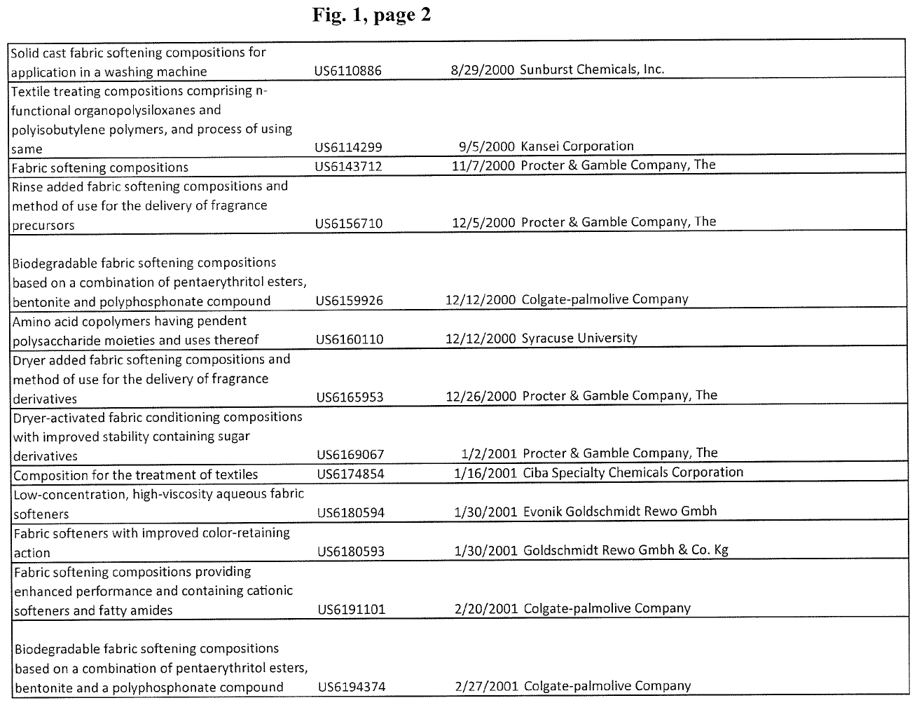

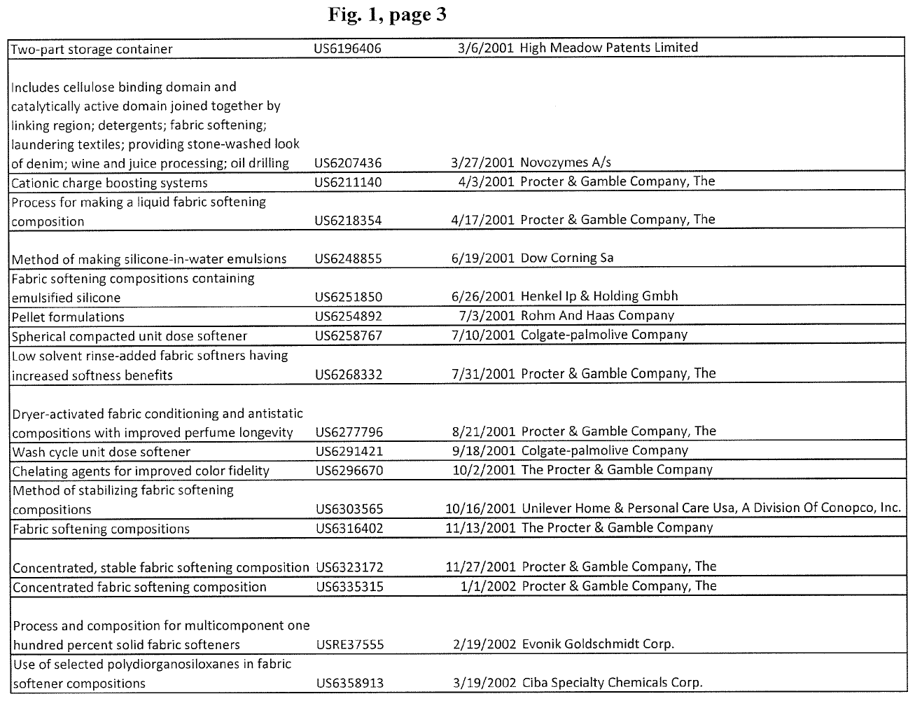

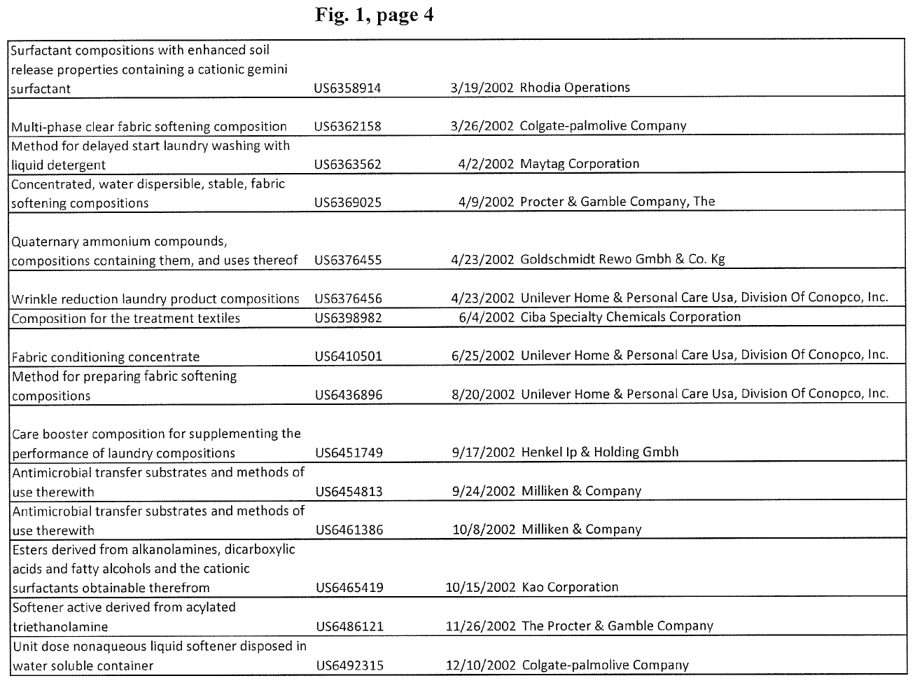

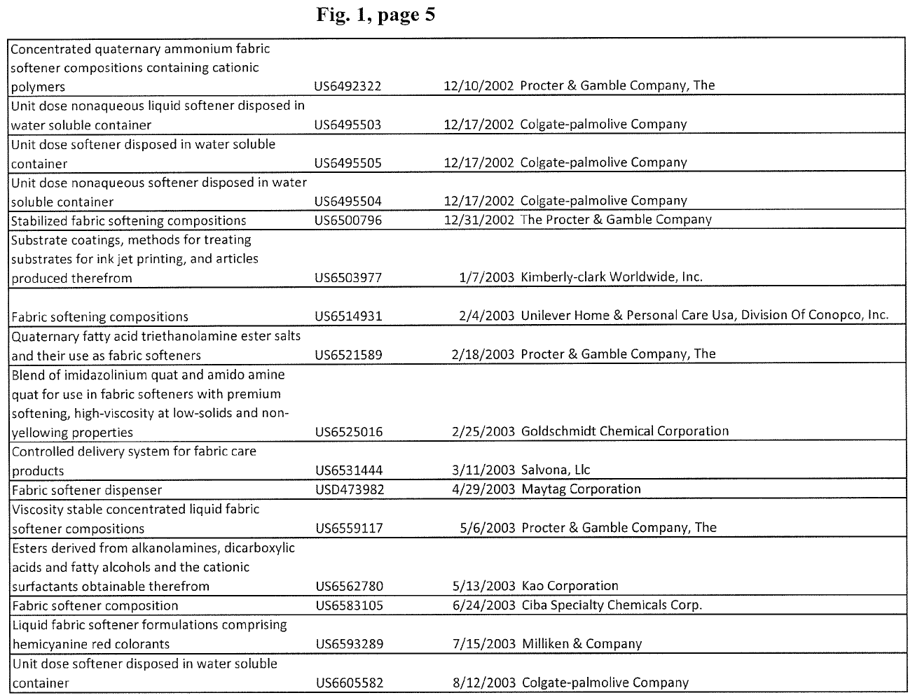

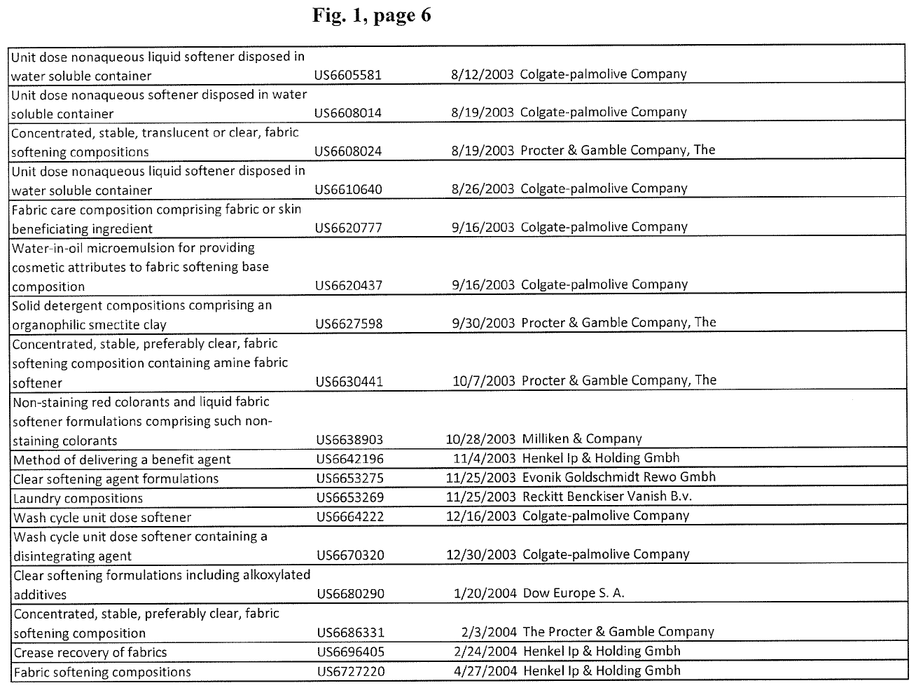

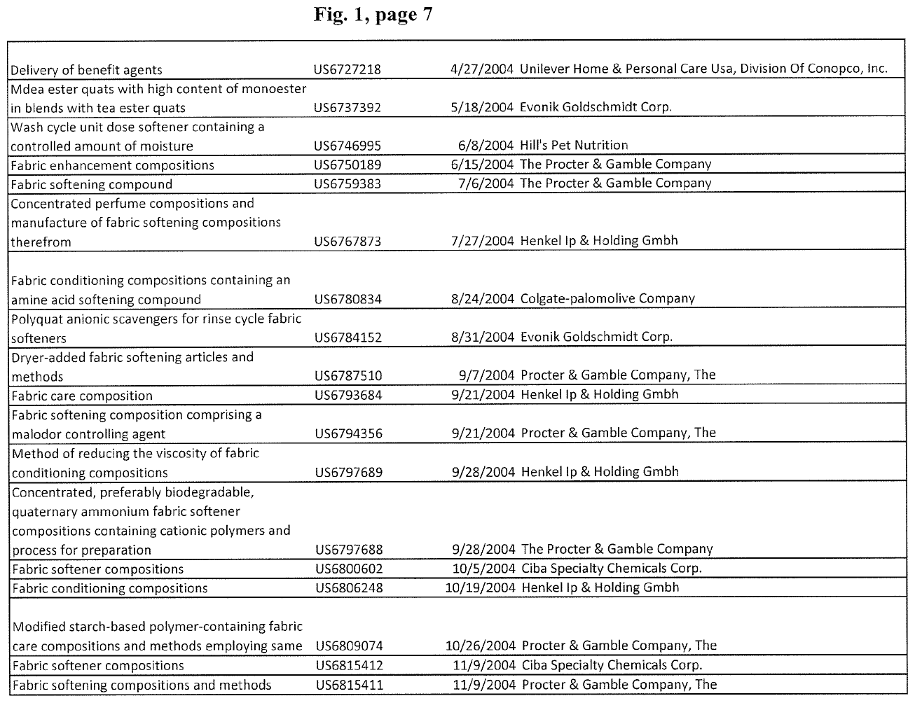

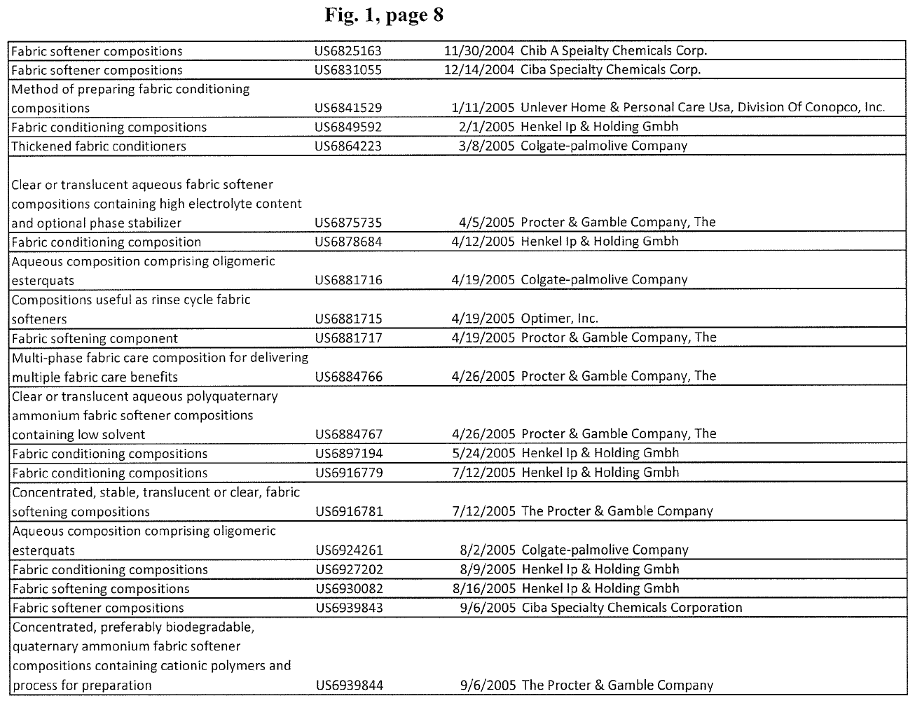

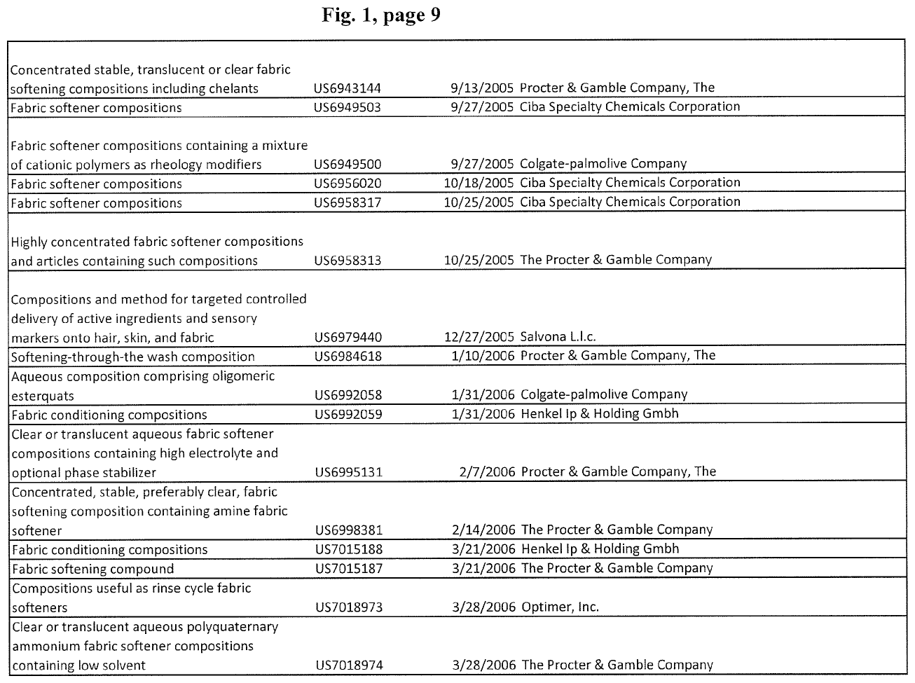

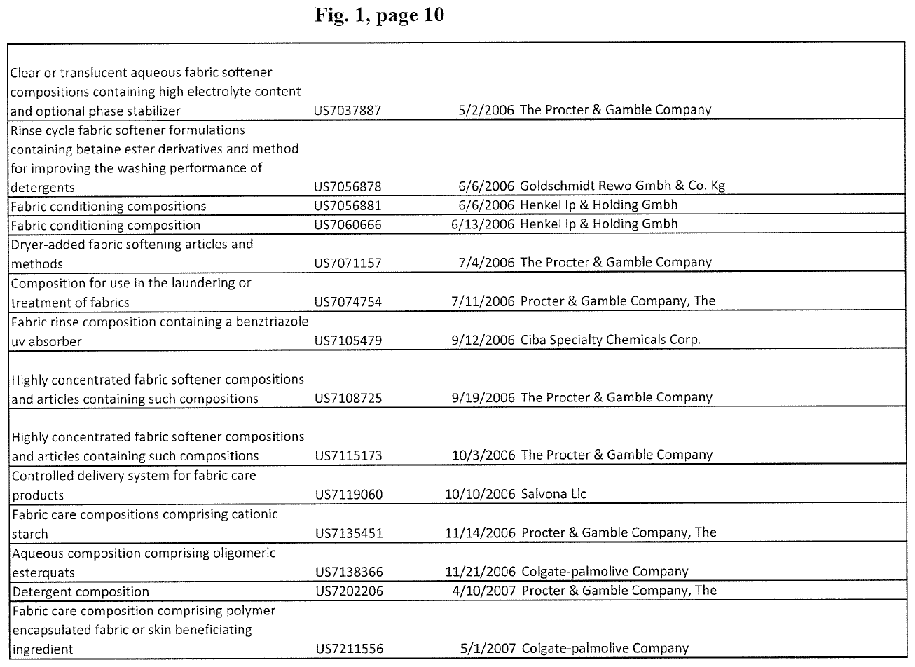

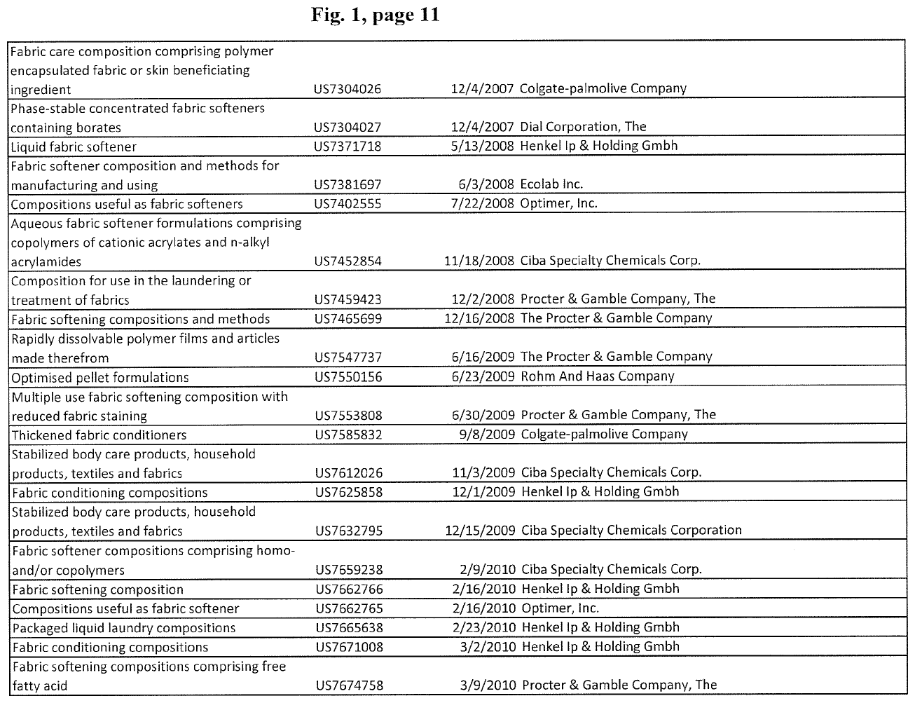

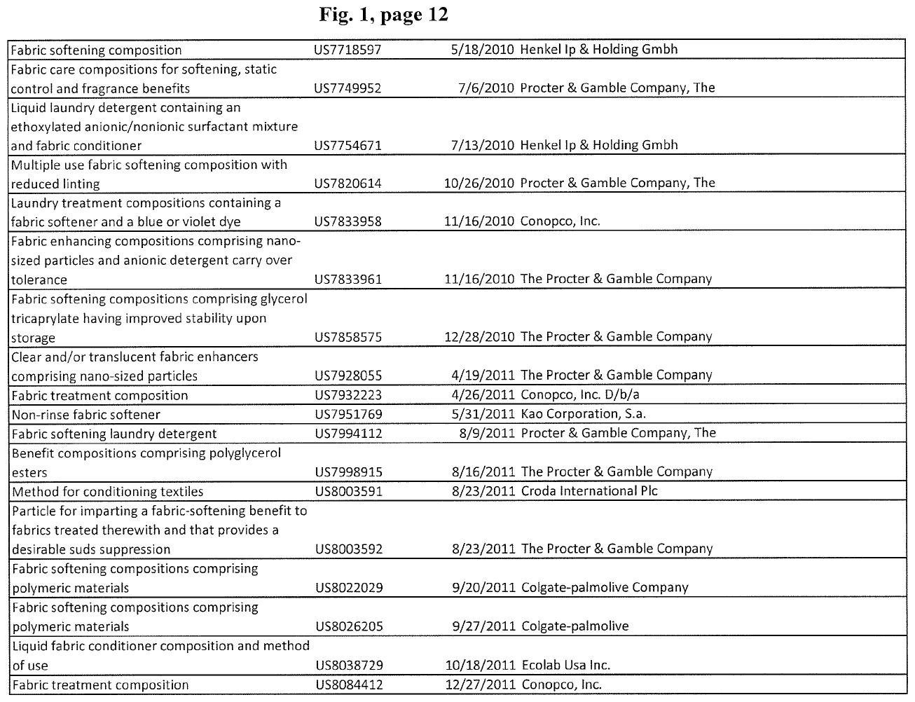

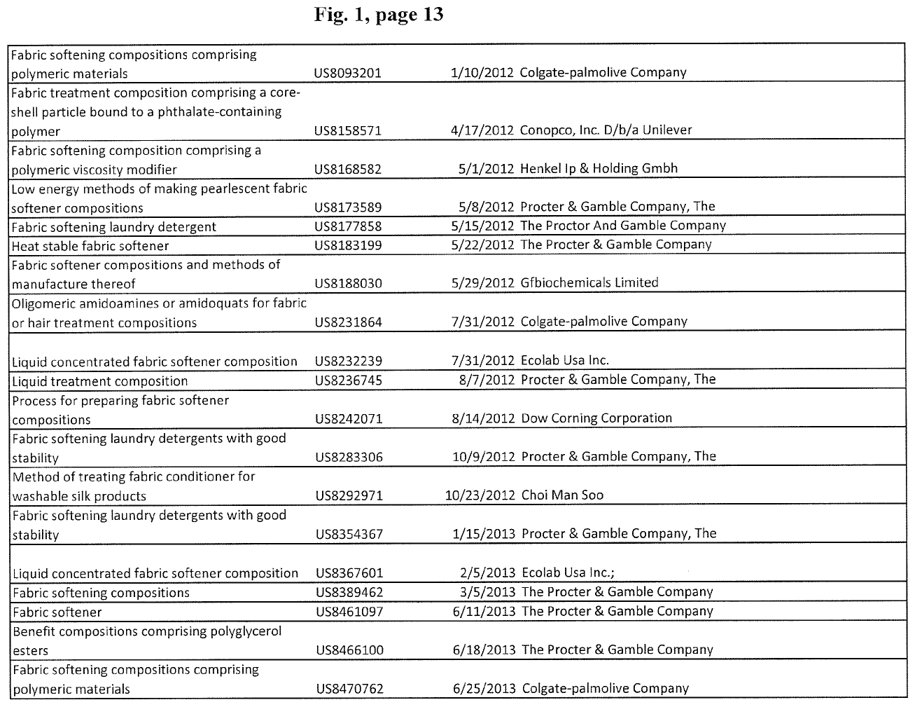

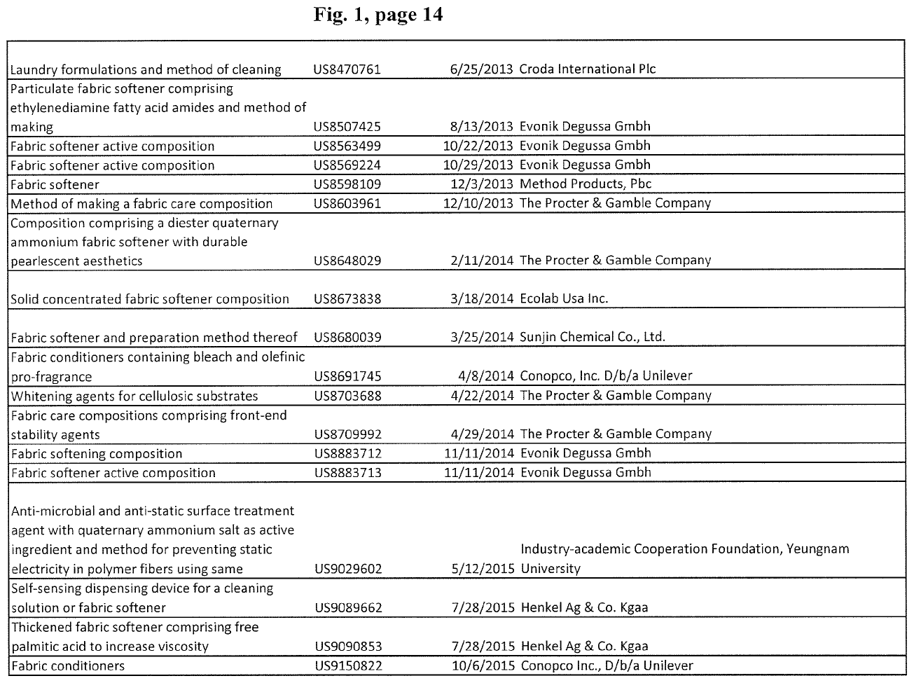

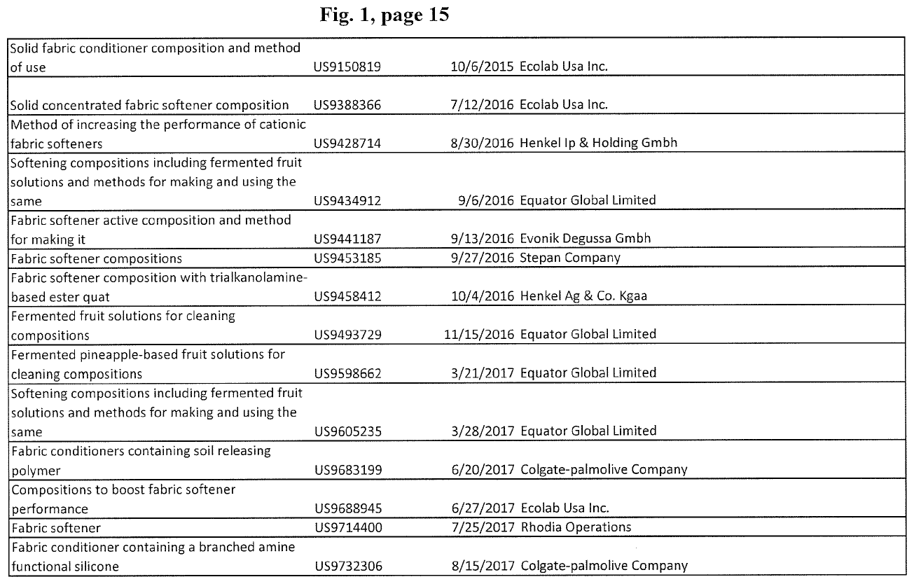

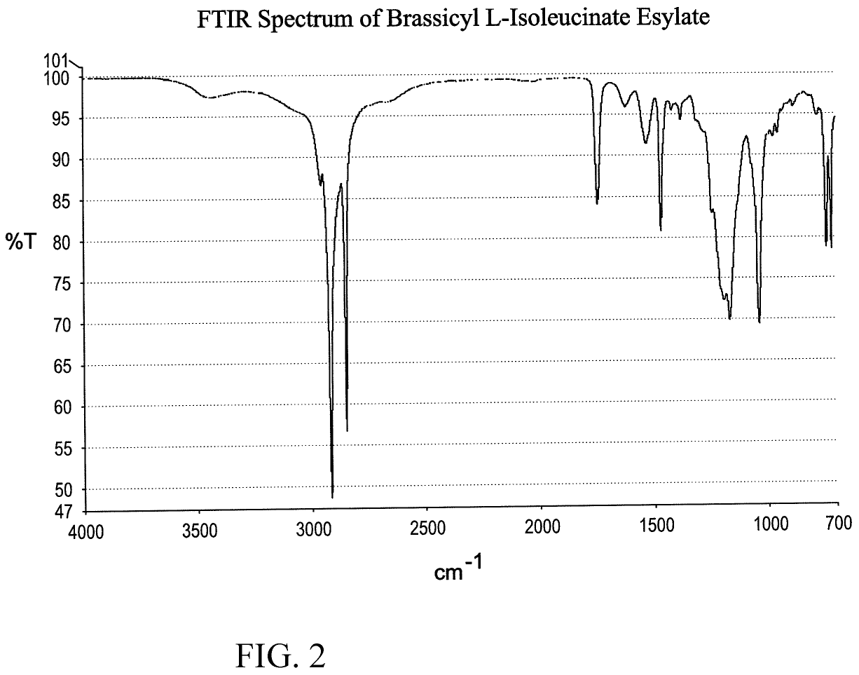

Other ingredients that may be incorporated into the fabric conditioning compositions of the invention include those identified in the United States patents listed in the table of FIG. 1. The contents of each of the patents listed in FIG. 1 are incorporated herein by reference in their entirety.

The process for making the fabric conditioning composition of the present invention can be prepared using any conventional mixing equipment, and any process commonly known in the art. In general terms, the process of manufacture is simple the addition of all the ingredients of the composition and sufficient mixing. It may be desirable that a premix that includes the carrier and any additional ingredients except the fabric conditioning agent(s) and fragrance (if used) is prepared separately, followed subsequently by incorporation of the fabric conditioning agent(s) and then by any fragrance (if used).

Also include within the scope of the invention are methods of conditioning textiles and/or the fibers of textiles. The methods include treatment of the finished textile and/or treatment of the fibers or yarns from which a textile is to be fabricated to achieve the desired benefit. Textiles may include woven and non-woven textiles, such as felt and tapa cloth and other bark cloths, or blends and combinations of the same.

Textile fiber (whether they exist in finished textile form, yarn or fiber form) may be any known or developed in the art and include synthetic fibers, “natural” fibers, such as animal derived fibers or cellulosic/plant-derived fibers and blends or combinations of any of these.

Animal-derived fibers may include and derived from the hairs or fur of an animal. Examples are, without limitation, lambs or sheeps wool, alpaca, angora wool, azlon, byssus, camel hair, cashmere wool, chiengora, chatgora, llama, mohair wool, qiviut, rabbit, silk, vicuna, yak, pashmina wool and combinations of the same.

Cellulosic or plant derived fibers may include, without limitation, those obtained from flax (linen fibers), ramie, jute, kenaf, beach hibiscus, roselle, urena, hemp (e.g., Crotalaria juncea, Cannabis sativa, Apocynum cannabinum), hoop vine, sisal, henequen, yucca, abaca, genus Sansevieria, New Zealand flax, cotton, coir, milkweed, kapok, floss silk, Proboscidea parviflora, bamboo, bast, Pique, banana, modal, lyocell, pina, raffia, rayon, soy protein, acetate and combinations of the same.

Synthetic fibers may include any known or to be developed, such as for example, and without limitation, acrylic, kevlar, modacrylic, nomex, nylon, polyester, spandex, rayon, and combinations of the same.

In the practice of the inventive methods, the composition is applied to the textile or fibers. The composition may be applied as either a wet or dry composition, and may be applied during a laundering cycle (e.g., when wash or rinse water is present) or a drying cycle (when textiles are water-saturated and being exposed to air and/or heat to remove the water.)

Methods include methods of softening and/or conditioning a textile or fiber; methods of reducing the occurrence of wrinkles and/or of preventing the permanence of wrinkles that may develop post-laundering; methods of imparting a fragrances to a textile or fiber; methods of reducing ironing time, methods of increasing wrinkle resistance, methods of improving softness and/or fabric hand and the like.

### EXAMPLES

### Example 1—Synthesis of Brassicyl L-Isoleucinate Esylate (BLIE)

To a one liter round bottom flask affixed with vapor column, total condenser, nitrogen sparge and agitator, 508.5 grams (1.629 moles) of Brassicyl alcohol and 106.9 grams (0.8147 moles) of L-isoleucine were charged. The mixture was warmed to 90° C. with stirring, and 134.5 grams (0.8551 moles) of a 70% solution of ethanesulfonic acid was added dropwise over about a twenty-minute period. The mixture was then heated to 140° C. and was held for about 16 hours. The mixture was then cooled to 90° C. and the excess of ethanesulfonic acid was neutralized with 1.8 grams of sodium carbonate dissolved in 5.6 grams of water. The mixture was then dried under hard vacuum for about one hour. The mixture was then cooled to about 70° C. and flaked off, yielding a pale yellow solid product.

Acid value was determined on the product using ASTM (American Society of Testing and Materials, West Conshohocken, Pa.) official method number D-972, the contents of which are incorporated herein by reference, and was found to be 2.67 mg KOH/g (95.9% conversion.) The amine value was determined through the use of multi-endpoint titration with base using a modern automatic titrator. In the method, a sample is weighed and dissolved in un-neutralized denatured ethanol. The mixture is then titrated with dilute sodium hydroxide to the appearance of two endpoints, the first being related to the consumption of carboxylate, and the second being related to the titration of the amine salt. The value found was 64.3 mg KOH/g. The infrared spectrum was determined using a Perkin-Elmer (Waltham, Mass.) Spectrum 100 FT-IR spectrophotometer fitted with a Pike (Madison, Wis.) MIRacle ATR (Attenuated Total Reflectance) accessory with ZnSe crystal. The spectrum is displayed in FIG. 1, and shows a prominent peak at 1745 cm-1 indicative of ester and the absence of any peak at 1670-1640 cm-1 indicative of the absence of amide. The melting point was determined using an SRS (Stanford Research Systems, Inc. Sunnyvale, Calif.) EZMelt automated melting point apparatus and was found to be 55° C.

This ester is incorporated into a fabric conditioning composition.

### Example 2

Additional analogs of BLIE were prepared and analyzed using the general methods described in Example 1, and the properties are summarized in Table 1.

TABLE 1

| | | Acid | Amine | |
|---|---|---|---|---|
| | | Value | Value | Melting |
| | | (mg | (mg | Point |
| Amino Acid | Fatty Alcohol | KOH/g) | KOH/g) | (° C.) |
| L-Alanine | Coconut | 0.0 | 106.6 | 78 |
| L-Alanine | Brassicyl (Hyd.) | 3.4 | 71.9 | 99 |
| L-Alanine | Stearyl | 5.5 | 114.6 | 114 |
| L-Alanine | Isostearyl | 1.7 | 76.9 | Paste at R.T. |
| L-Valine | Coconut | 2.5 | 109.0 | Paste at R.T. |
| L-Valine | Brassicyl (Hyd.) | 0.4 | 67.2 | 60 |
| L-Valine | Stearyl | 0.0 | 75.6 | 62 |
| L-Valine | Isostearyl | 1.2 | 73.7 | Liquid at R.T. |
| L-Leucine | Coconut | 2.0 | 97.7 | Liquid at R.T. |
| Leucine | Brassicyl (Hyd.) | 3.5 | 65.4 | 62 |
| L-Leucine | Stearyl | 2.1 | 73.0 | 59 |
| L-Leucine | Isostearyl | 1.8 | 72.1 | Liquid at R.T. |
| L-Isoeucine | Coconut | 5.3 | 103.1 | Liquid at R.T. |
| L-Isoeucine | Stearyl | 1.1 | 72.8 | 53 |

These esters are incorporated into a fabric conditioning composition.

### Example 3—Synthesis of Brassicyl Aminolaurate Esylate

To a one liter round bottom flask affixed with vapor column, total condenser, nitrogen sparge and agitator, about 1.2 moles of Brassicyl alcohol and about 1 mole of 12-aminolauric acid were charged. The Brassica alcohol used was a mixture of straight chain saturated fatty alcohols comprising palmityl (C₁₆), stearyl (C₁₈), arachidyl (C₂₀), and behenyl (C₂₂) alcohols derived from hydrogenated high erucic acid rapeseed (HEAR) oil. The typical weight percentages of each alcohol in the fatty alcohol mixture are about 3 wt. % palmitic, about 40 wt. % stearyl, about 10 wt. % arachidyl, and about 47 wt. % behenyl. These percentages can vary based upon seasonality, and varietal of rapeseed oil used as the parent vegetable source. The mixture was warmed to about 90° C. with stirring, and about 1 mole of ethanesulfonic acid was added dropwise over about a twenty-minute period. The mixture was then heated to 140° C. and was held for about 16 hours.

The mixture was then cooled to 90° C. and the excess of ethanesulfonic acid was neutralized by adding about 0.03 moles of sodium carbonate dissolved in about 6 grams of water. The mixture was then dried under hard vacuum for about one hour. The mixture was then cooled to about 80° C. and was flaked off, yielding a pale yellow solid product.

The amine value of the material was determined through the use of titration with base using a Metrohm Titrando 808 automatic titrator with Tiamo software (Metrohm USA, (Riverview, Fla. USA). In the method, a sample was weighed and dissolved in un-neutralized denatured ethanol. The mixture was then titrated with dilute sodium hydroxide to the appearance of an endpoint. The value found is 82 mg KOH/g. This was compared to the calculated theoretical amine number of 83 and the % conversion was determined which is approximately 100%.

The melting point was determined using an SRS (Stanford Research Systems, Inc. Sunnyvale, Calif., USA) EZMelt automated melting point apparatus and was found to be 83° C.

The pH was determined by dispersing the product at a level 10 wt. % in water with heat and agitation, then allowing the dispersion to cool. The pH of the material was measured using a Schott Lab 860 pH meter affixed with an IoLine 1L-pHT-A170MF-BNL-N electrode (SI Analytics GmbH, College Station, Tex., USA). It was determined to be 6.4.

This ester is incorporated into a fabric conditioning composition.

### Example 4—Preparation of Exemplary Agents of the Invention

Additional fabric conditioning agents for use in the compositions of the invention were prepared and analyzed using the general methods described in Example 3. There properties are summarized in Table 1.

TABLE 1

| | | | Actual | Theoretical | | Melting | |
|---|---|---|---|---|---|---|---|
| | Amino | Fatty | Amine Value | Amine Value | Conversion | Point | pH |
| Ester | Acid | Alcohol | (mg KOH/g) | (mgKOH/g) | (%) | (° C.) | (10% aqueous) |
| Octyldodecyl | 12- | isostearyl | 98.0 | 95.4 | 97.4 | 38 | 5.6 |
| aminolaurate | aminolauric | | | | | | |
| esylate (OAE) | | | | | | | |
| Isosteryl | 12- | octyldodecyl | 89.1 | 90.7 | 101.8 | 44 | 6.0 |
| aminolaurate | aminolauric | | | | | | |
| esylate (IAE) | | | | | | | |

### Example 5—Preparation of a Natural Fabric Conditioning Composition

A fabric conditioning composition is prepared by mixing the ingredients of the table below in the amounts shown at room temperature until a uniform mixture is obtained.

TABLE

| Ingredient | Amount (gms) |
|---|---|
| Water | 1000 |
| Agent of Example 1 | 2 |
| Carboxymethyl cellulose | 1 |
| (an antidepositon agent derived from non- | |
| GMO botanical sources) | |
| cyclohexyl salicylate (fragrance derived from | 1 |
| wintergreen herb) | |
| TOTAL | 1004 |

The resultant mixture is used a as a fabric conditioning agent that is delivered in a liquid form to the rinse cycle during the laundering process of a textile.

### Example 6—Evaluation of Fabric Conditioning Composition

Ten sets of identical factory-new garments are obtained as shown in the Table below.

TABLE

| Garment No. | Garment Type | Textile/Fiber Content |
|---|---|---|
| 1 | Denim pants (jeans) | 97% cotton and 3% elastane |
| 2 | Cardigan Sweater | 100% merino wool |
| 3 | Sleeveless tank-type shirt | 100% silk |
| 4 | “Dress” pants | 100% polyester |

The garments are divided in to two groups, each group having 10 of each of garments 1 to 4. The garments are subjected to a conventional laundering process in a household washing machine using cold water with a standard laundry detergent. To the rinse cycle of one set of garments (Group A) the laundering process is added ½ cup of the fabric conditioning composition of Example 5. The rinse cycle of the second set of garments (Group B) is water only.

### Softness Evaluation:

Garments 2 and 3 of each Group are air dried at room temperature on an interior line. Garments 1 and 4 are dried under low heat in a conventional household tumble dryer.

The garments from each group are evaluated by 50 individuals for softness as follows: each person was able to handle the garment for as long as he or she wished and rate its softness on a scale of 1 to 5 with 5 being “very soft.” Each person evaluated ten samples of each garment in each of Group A and B.

The data that are gathered demonstrates a higher rating of “softness” (on average, between 4 and 5) of the Group A garments. The softness of the Group B garments is rated lower (on average 3 to 4 for the tumbled dried garments, with ratings as low as 1-2 for the line dried garments).

Garment 1 of each of Group A and B is processed as above, then, when dry, crumpled into a box measuring 8 in×8 in×10 inches, to simulate packing of the garment for travel. The garments remain in the box for 3 weeks. When removed from the box, each garment is shaken out for 30 seconds, then laid on a horizontal surface for evaluation by visual observation. The Garments of Group A looked significant less crumpled and had fewer deep creases that those of Group B, the untreated group.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A composition for conditioning fabrics comprising a fabric conditioning agent selected from:
a) a neutralized amino acid ester represented by formula (I): 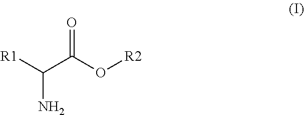
wherein R¹ is an alkyl group having one to ten carbon atoms and R² is a carbon chain having ten to fifty carbon atoms;
b) a neutralized amino acid ester represented by formula (II): 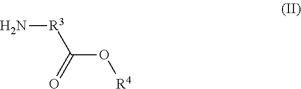
wherein R³ is an alkyl group having one to 6 to 24 carbon atoms and R⁴ independently represents an alkyl group having 6 to 36 carbon atoms; and
c) a mixture of a) and b); and
a carrier selected from water, an alcohol, and an alcoholic water mixture.

2. The composition according to claim 1, further comprising at least one additional ingredient selected from an antifoam agent, an antidepositon agent, a fragrance, a diol, a colorant and a co-softener.

3. The composition according to claim 1, comprising or further comprising at least one of a preservative, a bacteriocide, a fungicide, a pH buffering agent, a perfume carrier, a fluorescers, an hydrotropes, a soil-release agent, a polyelectrolyte, an enzyme, an optical brightening agent, an anti-shrinking agent, an anti-wrinkle agent, an anti-spotting agent, an anti-oxidant, an UV absorbing compound, an anti-corrosion agent, a drape imparting agent, an anti-static agents, an ironing aid, a dye, an antibacterial, an odor, preventing compound, a perfume encapsulate, cotton seed oil, tea tree oil, Aloe Vera extract, propylene glycol, dipropylene glycol, an opacifier, a pearlescer and mixtures of the same.

4. The composition according to claim 1 wherein the composition is natural.

5. A method of coating a textile fiber with a conditioner comprising applying the composition of claim 1 to the textile fiber.

6. The method of claim 5 further comprising drying the textile fiber.

7. The method of claim 5, fiber is selected from a cellulosic (plant) fiber, an animal fiber, a synthetic fiber and blends or combinations of the same.

8. The method of claim 6, wherein the fiber is selected from a sheeps or lambs wool fiber, a silk fiber, an angora fiber.

9. The method of claim 7, wherein the fiber is selected from a cotton fiber, a bamboo fiber, a hemp fiber, kapok and floss silk.

10. A method of conditioning a textile comprising applying an effective amount of the composition of claim 1 to the textile.

11. The method of claim 10 further comprising drying the textile.

12. A method of improving the wrinkle resistance of a textile comprising applying to the textile an effective amount of the composition of claim 1 to prepare a treated textile, wherein the treated textile resists wrinkles as compared to an untreated textile.

13. A method of improving the softness and/or the fabric hand of a textile comprising applying to the textile an effective amount of the composition of claim 1 to prepare a treated textile, wherein the treated textile exhibits improved softness and/or the fabric hand as compared to an untreated textile.

14. A method of preparing a natural composition for conditioning fabrics comprising mixing a fabric conditioning agent selected from: a) a neutralized amino acid ester represented by formula (I): 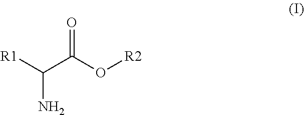
wherein R¹ is an alkyl group having one to ten carbon atoms and R² is a carbon chain having ten to fifty carbon atoms;
b) a neutralized amino acid ester represented by formula (II): 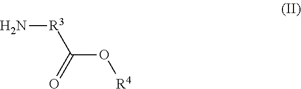
wherein R³ is an alkyl group having one to 6 to 24 carbon atoms and R⁴ independently represents an alkyl group having 6 to 36 carbon atoms; and c) a mixture of a) and b); and
a carrier, wherein the carrier is selected from selected from water, an alcohol, and an alcoholic water mixture, to form a fabric condition composition.

15. The method of claim 14 further comprising at least one of an antifoam agent, an antidepositon agent, a fragrance, a diol, a colorant, a co-softener, a preservative, a bacteriocide, a fungicide, a pH buffering agent, a perfume carrier, a fluorescers, an hydrotrope, a soil-release agent, a polyelectrolyte, an enzyme, an optical brightening agent, an anti-shrinking agent, an anti-wrinkle agent, an anti-spotting agent, an anti-oxidant, an UV absorbing compound, an anti-corrosion agent, a drape imparting agent, an anti-static agents, an ironing aid, a dye, an antibacterial, an odor, preventing compound, a perfume encapsulate, cotton seed oil, tea tree oil, Aloe Vera extract, propylene glycol, dipropylene glycol, an opacifier, a pearlescer.
